(19) United States
(12) Patent Application Publication
(10) Pub. No.: US 2022/0121325 A1
(43) Pub. Date: Apr. 21, 2022

(54) USER INTERFACE CUSTOMIZATION PER APPLICATION

(71) Applicant: Lenovo (Singapore) Pte. Ltd., Singapore (SG)

(72) Inventors: Nicholas Richard Roberts, Cary, NC (US); Alfredo Zugasti, Cary, NC (US); Fred F. Holt, JR., Cary, NC (US); Robert J. Kapinos, Durham, NC (US); Stephen Paul Floyd, Raleigh, NC (US)

(21) Appl. No.: 17/076,329

(22) Filed: Oct. 21, 2020

(51) Int. Cl. G06F 3/0481; G06F 3/0484

(52) U.S. Cl. CPC G06F 3/0481; G06F 2203/04803; G06F 3/04842

(57) ABSTRACT

An approach is provided that differentiates displayed windows from one another by applying visual effects to the borders of the displayed windows. The approach retrieving user-defined visual effects with each of the user-defined visual effects corresponding to a different application. Windows are on the display screen, with each of the windows corresponding to one of the applications. The displayed windows are differentiated from each other by applying the user-defined visual effects to a border of each of the windows.

### BACKGROUND

In traditional systems, window-type user interfaces can be filled with many types of windows, each of the windows being a user interface for a different application. Oftentimes the title bars of windows appearing on the display screen are obscured by other windows, making it difficult for a user to identify a desired window. This often results in confusing the user and having the user selecting (e.g., using a mouse-click, etc.) one or more wrong windows until the desired window is found. Selecting wrong windows is both frustrating to a user as well as leads to lost time and lower productivity as the user wastes time selecting multiple windows until a desired window is found.

### SUMMARY

An approach is provided that differentiates displayed windows from one another by applying visual effects to the borders of the displayed windows. The approach retrieving user-defined visual effects with each of the user-defined visual effects corresponding to a different application. Windows are on the display screen, with each of the windows corresponding to one of the applications. The displayed windows are differentiated from each other by applying the user-defined visual effects to a border of each of the windows.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a screen diagram showing both a single window with a uniquely colored boarder and menu bar and a composite showing multiple windows each with a unique border and menu bar;

FIG. 4 is a flowchart showing steps taken by a user to setup a user interface (UI) control that uniquely differentiates windows from one another;

FIG. 5 is a flowchart showing steps taken during use of a system utilizing the UI control differentiating windows from one another; and

FIG. 6 is a screen diagram showing the result (from FIG. 3) of a user selecting one of the windows that formerly appeared on the background.

### DETAILED DESCRIPTION

The figures show an approach that differentiates windows displayed on a display screen using visual effects, such as colors, patterns, and the like, on the borders of the windows. In one embodiment, the border also includes a title bar of each of the windows. In the approach, each application is assigned a unique visual effect, such as a unique color or a unique color/pattern combination. The visual effect assigned to the application is used on the border around the window displaying the application as well as the title bar of the window. The user can now find a desired window (application) based on the unique visual effect of the displayed border even if the title bar of the desired window is not visible because it is being overlaid by other windows. In one embodiment, applications can be grouped, such as by application type, so that when a window of one of the applications in the group is selected, each of the applications included in the group have their respective windows moved to the foreground before other windows that are not included in the same group and the specific window that the user selected is placed in the foreground on top of all of the other displayed windows with user input focused on the user selected window. In one embodiment, windows in the same group have common visual effect, such as a common base color. For example, all of the applications that are application type “productivity” might have a base color of “red” with the specific applications included in the group being further differentiated from each other while still having the base red border color (e.g., one application colored light red, another application colored darker red, etc.). In addition, patterns can be utilized to differentiate between window borders, such as having one window with a solid colored border, another window having long dashed lines of the base color, and yet another window having diagonal hashes of the base color, etc.

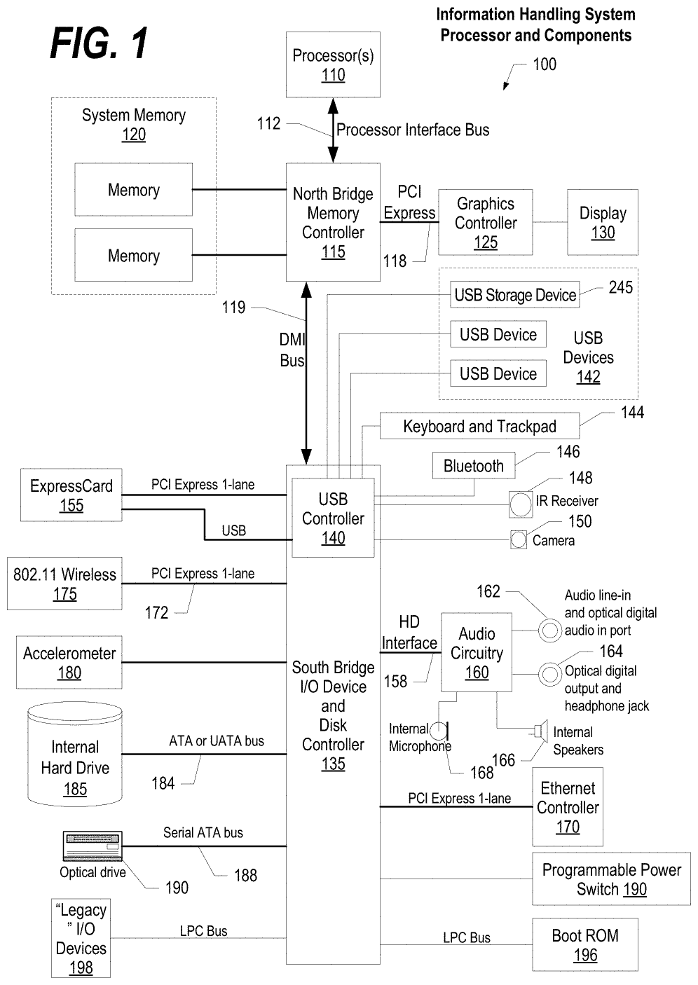

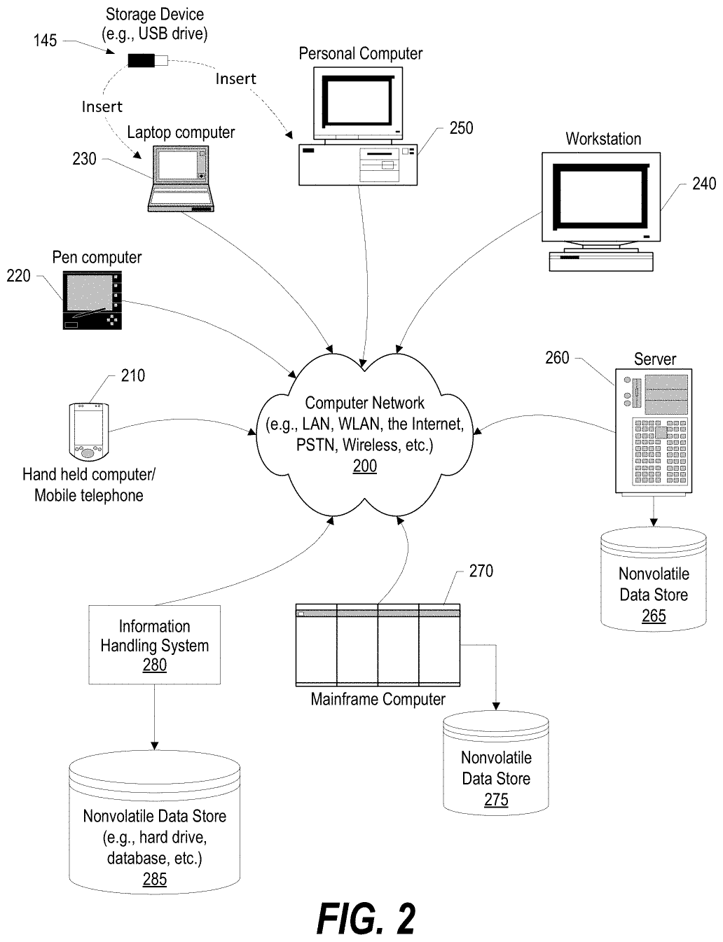

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a device that is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Accelerometer 180 connects to Southbridge 135 and measures the acceleration, or movement, of the device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may be a device that can take many forms. For example, an information handling system may take the form of a desktop device, server device, portable device, laptop device, notebook device, or other form factor device. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of devices that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling system devices include pen, or tablet, device 220, laptop, or notebook, device 230, workstation device 240, personal computer system device 250, and server device 260. Other types of information handling system devices that are not individually shown in FIG. 2 are represented by information handling system device 280. As shown, the various information handling system devices can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

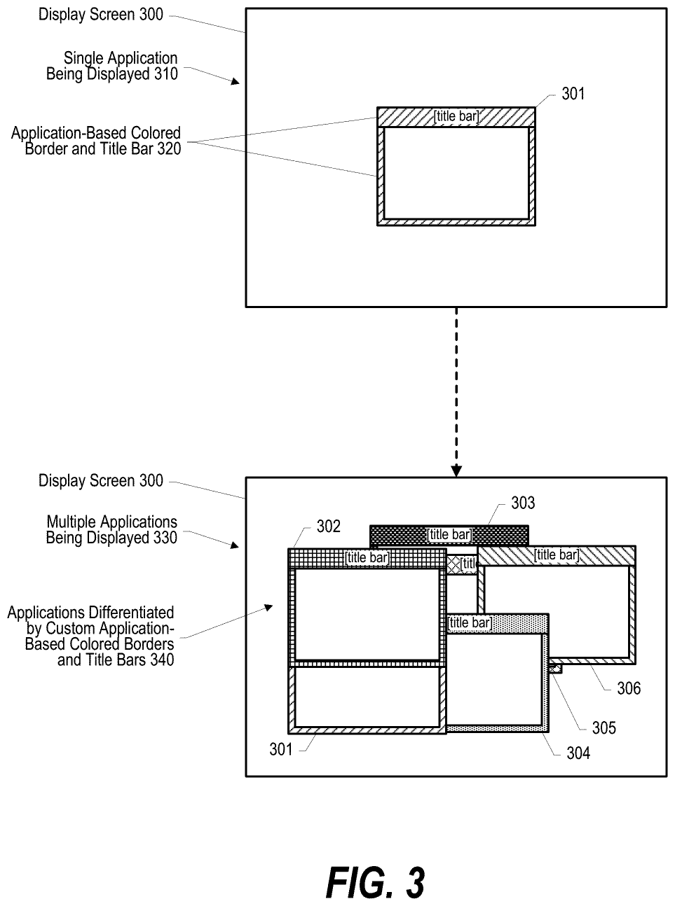

FIG. 3 is a screen diagram showing both a single window with a uniquely colored boarder and menu bar and a composite showing multiple windows each with a unique border and menu bar. At the top of the Figure, display screen 300 is shown with single application (301) being displayed with application based colored border and title bar 320. At the bottom of the Figure, the same display 300 is depicted now having multiple applications 330 being displayed, some of which overlay others making it difficult, or sometimes impossible, to see the application window area and/or the title bar of the respective window. Here, applications are differentiated by custom application-based borders and title bars 340. Windows 301, 302, 303, 304, 305, and 306 each appear with visual effects on their respective borders with the borders including the respective windows' title bars.

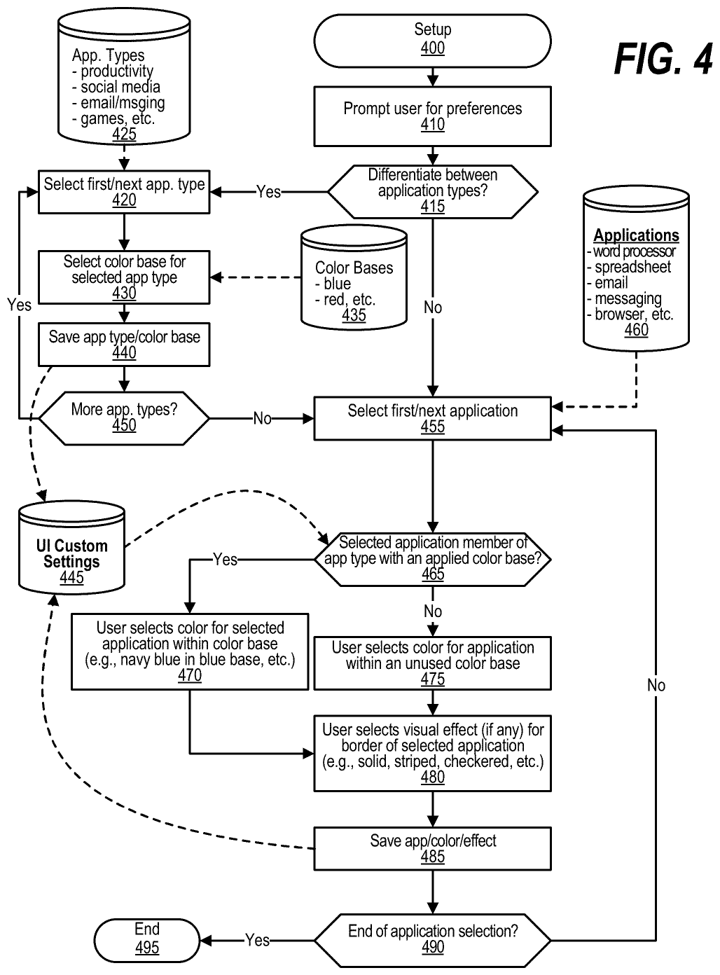

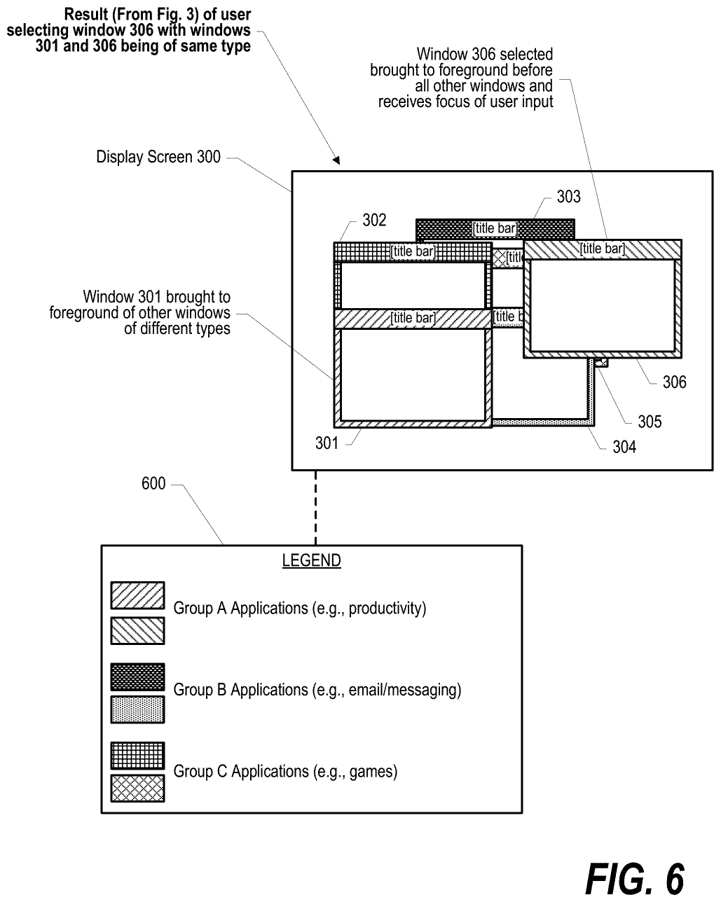

In one embodiment, applications can be grouped by type or however the user wishes to group applications, as shown in the setup procedure depicted in FIG. 4. In a further embodiment, when a member of the group is selected by the user (e.g., by “clicking” on a window with a mouse-pointer, etc.), then the selected window is moved to the foreground appearing on top of all of the other windows and the other members of the group are moved to the foreground on top of the windows that do not belong to the group. The window selected by the user receives “focus” so that user inputs are directed to the focused window. In addition, the window with focus is highlighted in a manner indicating that the window has focus. An example of a user selecting a member of a group with various groups defined is depicted in FIG. 6.

FIG. 4 is a flowchart showing steps taken by a user to setup a user interface (UI) control that uniquely differentiates windows from one another. FIG. 4 processing commences at 400 and shows the steps taken by a process that performs setup processing. At step 410, the process prompts the user for preferences, such as whether application groups are used and whether to move all windows of an application group to the foreground when one of the group's members is selected by the user.

The process determines as to whether the user has requested to differentiate between applications by grouping the applications (decision 415). If the user has requested to differentiate between applications by grouping the applications, then decision 415 branches to the ‘yes’ branch to perform steps 420 through 450. On the other hand, if applications are not being grouped, then decision 415 branches to the ‘no’ branch bypassing steps 420 through 450.

When applications are being grouped, then steps 420 through 450 are performed. At step 420, the process receives the first group identifier from the user, such as grouping by application type with all productivity applications being grouped together. In addition, the user can create a group that spans different types of applications, such as messaging application, a word processing application, and a calendaring application that are used together when the user is performing a particular task. In one embodiment, various types of groups are selected by the user from data store 425 with the user having the ability to create additional groups not found in the list provided in data store 425. At step 430, the user selects a visual effect, such as a color base, to use for the selected group. For example, a productivity group might be assigned a “red” base, while a social media group is assigned a “blue” base, email/messaging is assigned a “green” base, and a game group is assigned a “yellow” base. Each of the applications in the respective group uses the base visual effect and then applies changes (e.g., different shades, color patterns, etc.) to differentiate between applications included in the same group. For example, in the productivity group, a “calendar” application might be assigned a light red color, a word processing application can be assigned a brick red color, and an email application can be applied a maroon color. At step 440, the process saves the group and base visual effect (e.g., color base, common visual pattern, etc.) to data store 445 that is used to store the user's customer user interface (UI) settings. The process determines as to whether the user wishes to create additional application groups (decision 450). If the user wishes to create additional application groups, then decision 450 branches to the ‘yes’ branch which loops back to step 420 to make the next application group as described above. This looping continues until no more groups are being created, at which point decision 450 branches to the ‘no’ branch exiting the loop.

At step 455, the user selects the first application from the list of applications stored in data store 460 (e.g., the applications residing on the information handling system, etc.). The process determines as to whether the selected application is a member of an application group set up by steps 420 through 450. In one embodiment, the user can decide whether an application should be a member of any particular previously defined groups (decision 465). If the selected application is member of a previously defined group, then decision 465 branches to the ‘yes’ branch whereupon, at step 470, the process or the user selects a visual effect for the selected application within the visual base of the group (e.g., navy blue in blue colored group base, etc.).

On the other hand, if the selected application is not a member of a defined group, then decision 465 branches to the ‘no’ branch whereupon, at step 475, the process or the user selects a visual effect for the selected application that is within visual base that is not assigned to a group. For example, all applications not in a defined group may use an “orange” base color. At step 480, the user can select additional visual effects (if any) to apply to the border of windows displaying the selected application (e.g., a patterned border (solid, striped, checkered, etc.). At step 485, the process saves the application and its assigned visual effects to data store 445. The process determines as to whether the user is ending application selection (decision 490). If the user is not ending application selection, then decision 490 branches to the ‘no’ branch which loops back to step 455 to select the next application that will be assigned a custom border visual effect as described above. This looping continues until the user ends selection of applications, at which point decision 490 branches to the ‘no’ branch exiting the loop and setup processing ends at 495.

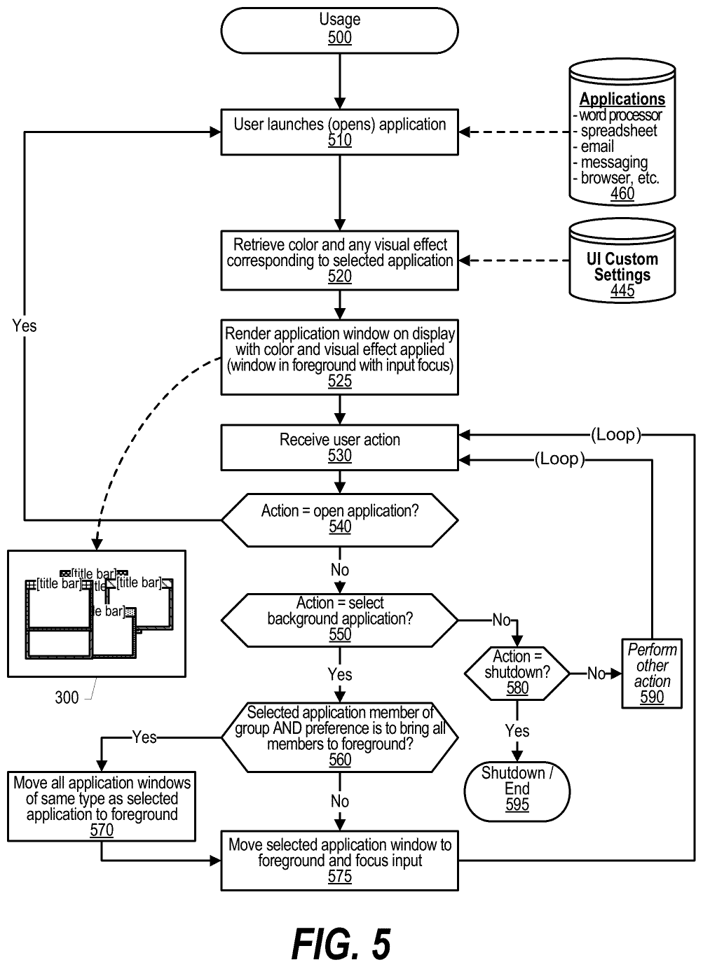

FIG. 5 is a flowchart showing steps taken during use of a system utilizing the UI control differentiating windows from one another. FIG. 5 processing commences at 500 and shows the steps taken by a process that handles user inputs while the user is using the system with custom user interface (UI) controls that distinguish between displayed windows. At step 510, the process launches (opens) an application selected by the user with the applications shown stored in data store 460 (e.g., a nonvolatile storage area of the system, such as a hard drive, etc.).

At step 520, the process retrieves the visual effects, such as the color, patterns, etc. that correspond to the application that was selected by the user. The visual effects are retrieved from data store 445 which was created during the setup process shown in FIG. 4. At step 525, the process renders a window in which the application is displayed on the display screen with the visual effects that were retrieved at step 520 applied to the window's border. The window is displayed in the foreground with user input (e.g., keystrokes, etc.) focus on this window. Application windows that are opened appear on display screen 300.

At step 530, the process receives a user action from the user. The process determines as to whether the user action is to open another application (decision 540). If the user action is to open another application, then decision 540 branches to the ‘yes’ branch which loops back to open (launch) the application requested by the user and display the newly opened application in a window with a border corresponding to the newly opened application as described above. On the other hand, if the user action was not to open an application, then decision 540 branches to the ‘no’ branch to process the user action.

The process determines as to whether the user action is selecting a background application that currently does not have focus (decision 550). If the user action is selecting a background application that currently does not have focus, then decision 550 branches to the ‘yes’ branch to process the selection as shown in steps 560 through 575. On the other hand, if the user action is not to select a background application, then decision 550 branches to the ‘no’ branch to process other actions as shown in steps 580 through 590.

When a background application window is selected, then the process determines whether the application corresponding to the selected window is a member of a group and that the user preference is to bring all members of the group to the foreground (decision 560). If the application corresponding to the selected window is a member of a group and that the user preference is to bring all members of the group to the foreground, then decision 560 branches to the ‘yes’ branch whereupon at step 570 the process moves all application windows that are in the same group as the selected application to foreground. For example, if the selected window was a word processing application window that is part of the “productivity” group, then other windows corresponding to other applications (e.g., spreadsheet, database, etc.) in this same group are moved to the foreground to appear before windows of applications that are not in this group (e.g., on top of social media windows, game windows, etc.) On the other hand, if either the selected application member is not a member of a group or if the user preference is not to bring all members to foreground, then decision 560 branches to the ‘no’ branch bypassing step 570. At step 575, the process moves the application window that was selected by the user to the foreground (appearing before, or on top of, all other windows) and processing focuses user input on this window. Processing then loops back to step 530 to receive the next user action.

Returning to decision 550, if the action was not to select a background window, then the process determines whether the user action is to shut down the system (decision 580). If the user action is not to shut down the system, then decision 580 branches to the ‘no’ branch whereupon, at step 590, the other type of user action is processed and processing loops back to step 530 to receive and process the next user input. This looping continues until the system is shutdown, at which point decision 580 branches to the ‘yes’ branch and processing ends at 595 with the system being shut down.

FIG. 6 is a screen diagram showing the result (from FIG. 3) of a user selecting one of the windows that formerly appeared on the background. Display screen 300 depicts the set of windows that was displayed at the bottom of FIG. 3 with each window having different visual effects applied to their borders. Display 300 in FIG. 6 shows the set of windows just after window 306 was selected by the user.

Legend 600 depicts grouping that has been defined by the user with group A applications, such as productivity, having diagonal patterns on their borders, group B applications, such as email/messaging applications, having dotted borders, and group C applications, such as game applications, having hatch pattern borders.

When window 306 is selected by the user, then (when user preference so indicates), window 301 and 306 (both in group A) are both brought to the foreground to appear before (on top of) other windows of applications that are not in group A. In addition, window 306 appears in the foreground of all windows (appearing over window 301 if occupying the same screen space) and window 306 receives input focus of the user's input (e.g., keyboard strokes, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. As used herein, a computer readable storage medium does not include a transitory signal.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While particular embodiments have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to others containing only one such element, even when the same claim includes the introductory phrases “one or more” or “at least one” and indefinite articles such as “a” or “an”; the same holds true for the use in the claims of definite articles.

1. A method, implemented by an information handling system comprising a processor, a memory accessible by the processor, and a display screen, the method comprising:
retrieving a plurality of user-defined visual effects, wherein each of the user-defined visual effects corresponds to a different one of a plurality of applications;
displaying a plurality of windows on the display screen, wherein each of the plurality of windows corresponds to one of the plurality of applications; and
differentiating each of the plurality of windows by applying the user-defined visual effects to a border of each of the plurality of windows.

2. The method of claim 1 wherein each of the borders includes a title bar of the respective window.

3. The method of claim 1 wherein the user-defined visual effects include a plurality of colors.

4. The method of claim 1 wherein one or more groups have been established, wherein a first set of the plurality of applications is associated with a first one of the groups, the method further comprising:
receiving a user selection of a first window, wherein the first window corresponds to a first of the plurality of applications that belongs to the first set of applications; responsive to the user selection:
displaying each of the windows corresponding to each of the first set of applications in a foreground over each of the windows corresponding to one or more of the plurality of applications not included in the first group; and
displaying the first window in the foreground over all other windows included in the plurality of windows.

5. The method of claim 1 wherein one or more groups have been established, the method further comprising:
identifying an application type corresponds to each of the plurality of applications, wherein each of the application types is one of the groups.

6. The method of claim 5 wherein each of the groups is associated with a base visual effect, wherein each of the applications included in each of the groups is associated with the base visual effect and a unique visual effect, wherein the unique visual effect differentiates each of the applications from the other applications included in the same group.

7. The method of claim 6 wherein the base visual effect is a color base and wherein each of the unique visual effects is a shade of the base visual effect.

8. An information handling system comprising:
one or more processors;
a memory coupled to at least one of the processors;
a display screen; and
a set of computer program instructions stored in the memory and executed by at least one of the processors in order to perform actions comprising:
retrieving a plurality of user-defined visual effects, wherein each of the user-defined visual effects corresponds to a different one of a plurality of applications;
displaying a plurality of windows on the display screen, wherein each of the plurality of windows corresponds to one of the plurality of applications; and
differentiating each of the plurality of windows by applying the user-defined visual effects to a border of each of the plurality of windows.

9. The information handling system of claim 8 wherein each of the borders includes a title bar of the respective window.

10. The information handling system of claim 8 wherein the user-defined visual effects include a plurality of colors.

11. The information handling system of claim 8 wherein one or more groups have been established, wherein a first set of the plurality of applications is associated with a first one of the groups, the actions wherein the actions further comprise:
receiving a user selection of a first window, wherein the first window corresponds to a first of the plurality of applications that belongs to the first set of applications;
responsive to the user selection:
displaying each of the windows corresponding to each of the first set of applications in a foreground over each of the windows corresponding to one or more of the plurality of applications not included in the first group; and
displaying the first window in the foreground over all other windows included in the plurality of windows.

12. The information handling system of claim 8 wherein one or more groups have been established, the actions wherein the actions further comprise:
identifying an application type corresponds to each of the plurality of applications, wherein each of the application types is one of the groups.

13. The information handling system of claim 12 wherein each of the groups is associated with a base visual effect, wherein each of the applications included in each of the groups is associated with the base visual effect and a unique visual effect, wherein the unique visual effect differentiates each of the applications from the other applications included in the same group.

14. The information handling system of claim 6 wherein the base visual effect is a color base and wherein each of the unique visual effects is a shade of the base visual effect.

15. A computer program product comprising:
a computer readable storage medium, comprising computer program code that, when executed by an information handling system, executes actions comprising:
retrieving a plurality of user-defined visual effects, wherein each of the user-defined visual effects corresponds to a different one of a plurality of applications;
displaying a plurality of windows on a display screen, wherein each of the plurality of windows corresponds to one of the plurality of applications; and
differentiating each of the plurality of windows by applying the user-defined visual effects to a border of each of the plurality of windows.

16. The computer program product of claim 15 wherein each of the borders includes a title bar of the respective window.

17. The computer program product of claim 15 wherein the user-defined visual effects include a plurality of colors.

18. The computer program product of claim 15 wherein one or more groups have been established, wherein a first set of the plurality of applications is associated with a first one of the groups, the actions wherein the actions further comprise:
receiving a user selection of a first window, wherein the first window corresponds to a first of the plurality of applications that belongs to the first set of applications;
responsive to the user selection:
displaying each of the windows corresponding to each of the first set of applications in a foreground over each of the windows corresponding to one or more of the plurality of applications not included in the first group; and
displaying the first window in the foreground over all other windows included in the plurality of windows.

19. The computer program product of claim 15 wherein one or more groups have been established, the actions wherein the actions further comprise:
identifying an application type corresponds to each of the plurality of applications, wherein each of the application types is one of the groups.

20. The computer program product of claim 19 wherein each of the groups is associated with a base visual effect, wherein each of the applications included in each of the groups is associated with the base visual effect and a unique visual effect, wherein the unique visual effect differentiates each of the applications from the other applications included in the same group.
